(19) United States
(12) Patent Application Publication
(10) Pub. No.: US 2025/0106161 A1
(43) Pub. Date: Mar. 27, 2025

(54) DECOUPLING CONGESTION MANAGEMENT STATE AND CONNECTION MANAGEMENT STATE IN HIGH PERFORMANCE COMPUTING

(71) Applicant: Hewlett Packard Enterprise Development LP, Spring, TX (US)

(72) Inventors: Keith D. Underwood, Powell, TN (US); Robert L. Alverson, Seattle, WA (US)

(21) Appl. No.: 18/408,288

(22) Filed: Jan. 9, 2024

Related U.S. Application Data
(60) Provisional application No. 63/584,676, filed on Sep. 22, 2023.

(51) Int. Cl. H04L 47/12; H04L 47/62

(52) U.S. Cl. CPC H04L 47/12; H04L 47/62

(57) ABSTRACT

A first network endpoint establishes a connection with a second network endpoint by transmitting a control packet including a first identifier associated with the connection and the first network endpoint. The first network endpoint stores, in a first data structure based on the first identifier, a first connection state associated with the connection and stores, in a second data structure based on the first connection state, a first congestion state associated with the connection. The first network endpoint identifies, for a data flow associated with the first identifier, a congestion state corresponding to the data flow, by: obtaining the first connection state by searching the first data structure based on the first identifier; and identifying the first congestion state by searching the second data structure based on the obtained first connection state.

### RELATED APPLICATION

This application claims the benefit of U.S. Provisional Application No. 63/584,676, Attorney Docket Number P173311USPRV, entitled “DECOUPLING CONGESTION MANAGEMENT STATE AND CONNECTION STATE IN A HIGH PERFORMANCE NIC,” by inventors Keith D. Underwood and Robert L. Alverson, filed 22 Sep. 2023.

### BACKGROUND

### Field

Congestion management can be a fundamental process in modern high performance datacenters. High bandwidth networks in these datacenters may experience congestion, e.g., at the midplane or at the endpoints. In order to manage the congestion, network endpoints (e.g., network interface controllers (NICs)) may maintain congestion management state, which can include information about how much data may be allowed into the network and the quality of the paths through the network. In most current solutions, the congestion management state is associated with the connection state, where each connection can independently maintain its connection state. In some cases, a network may include two or more connections between a single pair of endpoints, where each connection is associated with its own congestion management state. As a result, the duplication of the congestion management state may incur a space cost. In addition, congestion management may not perform efficiently when two flows from one NIC complete with each other for the bandwidth of the NIC.

### BRIEF DESCRIPTION OF THE FIGURES

FIG. 1 illustrates an exemplary network architecture, in accordance with an aspect of the present application.

FIG. 2A illustrates pseudocode for creating and accessing two data structures for a connection state and a congestion state, based on an indirection index, in accordance with an aspect of the present application.

FIG. 2B illustrates a diagram depicting information stored and accessed in the connection array and the congestion array shown in FIG. 2A, in accordance with an aspect of the present application.

FIG. 3A illustrates pseudocode for creating and accessing two data structures for a connection state and a congestion state, based on an encoding of an identifier, in accordance with an aspect of the present application.

FIG. 3B illustrates a diagram depicting information stored and accessed in the connection array and the congestion array shown in FIG. 3A, in accordance with an aspect of the present application.

FIG. 4A illustrates pseudocode for creating and accessing two data structures for a connection state and a congestion state, based on an encoding of an identifier and including multiple connection states embedded in the congestion state, in accordance with an aspect of the present application.

FIG. 4B illustrates a diagram depicting information stored and accessed in the connection array and the congestion array shown in FIG. 4A, in accordance with an aspect of the present application.

FIG. 5 presents a flowchart illustrating a method which facilitates decoupling congestion management and connection state in a NIC, in accordance with an aspect of the present application.

FIG. 6 illustrates a computer system which facilitates decoupling congestion management and connection state in a NIC, in accordance with an aspect of the present application.

FIG. 7 illustrates a computer-readable medium which facilitates decoupling congestion management and connection state in a NIC, in accordance with an aspect of the present application.

In the figures, like reference numerals refer to the same figure elements.

### DETAILED DESCRIPTION

The following description is presented to enable any person skilled in the art to make and use the aspects and examples, and is provided in the context of a particular application and its requirements. Various modifications to the disclosed aspects will be readily apparent to those skilled in the art, and the general principles defined herein may be applied to other aspects and applications without departing from the spirit and scope of the present disclosure. Thus, the aspects described herein are not limited to the aspects shown, but are to be accorded the widest scope consistent with the principles and features disclosed herein.

The described aspects address the loss of efficiency and performance when each connection between endpoints in a network must maintain its own congestion management state, by decoupling the congestion management state from the connection state and maintaining the connection state and the congestion state in separate data structures.

As described above, congestion management can be a fundamental process in modern high performance datacenters. High bandwidth networks in these datacenters may experience congestion at the network endpoints, e.g., NICs. In order to manage the congestion, the network endpoints may maintain congestion management state, which can include information about how much data may be allowed into the network (e.g., the “window size”) and the quality of the paths through the network. In most current solutions, the congestion management state is associated with the connection state, where each connection can independently maintain its connection state.

In some cases, a network may include two or more connections between a single pair of endpoints, where each connection is associated with its own congestion management state. One reason to include multiple connections may be due to performance, e.g., multiple packets may be needed to sustain the full packet rate. Another reason to include multiple connections may be due to a need for concurrency in data flows. Two or more different applications may wish to send data between the same pair of endpoints without interference, e.g., due to different types of traffic, which may not require a connection at all. For example, a target node may send “bulk data” in response to a read request from an initiator node. Congestion control may be desired for the transmitted bulk data of the response (i.e., from the target node to the initiator node), but there may not be a connection flowing in the reverse direction (e.g., from the initiator node to the target node).

When two or more connections, each with their own congestion management state, share a single data path between a pair of endpoints (e.g., between a pair of NICs), this may result in a loss of both efficiency and performance. Similarly, when one or more connections share a single data path with a dataflow that does not require a connection between the pair of endpoints, this may also result in a loss of both efficiency and performance. In one example, the HPE Cray Slingshot network may not use a connection for data sent in response to a request for the data. In this example, the initiator node (a first NIC) may issue a “Get” or “Read” operation to a target node (a second NIC). The target node may provide the requested data in response to the “Get” or “Read” operation, but the transmission of the response may not use a connection.

Some current solutions may lack the ability to tie together the congestion management state for response data (i.e., flowing from the target node to the initiator node) and the congestion management state for requests which are flowing in the same direction (i.e., requests from the target node to the initiator node). Similarly, some current solutions may be limited to only a single connection between a pair of NICs, due to the loss of efficiency and performance from having an independent congestion management state for separate connections.

In one example of efficiency loss, the duplication of the congestion management state may incur a space cost. Congestion management state may constitute 32 bytes or more of information, and replication of this information may incur a cost in silicon area. In one example of performance loss, congestion management may not perform efficiently when two flows from one NIC complete with each other for the bandwidth of the NIC.

Moreover, “connections” in networks may be dynamic and transient. Connections in networks may be established in order to transmit data and may be torn down after a certain period of time without any transmission of data. Techniques which may be appropriate for static, long-lasting, persistent connections may not be as effective in the domain of dynamic, transient connections.

The described aspects address the above-described challenges by decoupling the congestion management state from the connection state, using three main solutions which can maintain the connection state and the congestion state in separate data structures. In the first solution, the connection state table can include an “indirection index,” i.e., an index into the corresponding element of the congestion state table. In a second solution, an encoding of a connection identifier can be used to directly index into the congestion state table and to identify the congestion state associated with a connection state. In a third solution, which is based on the second solution, the encoding can be used to directly index into the congestion state, where corresponding connection states for the congestion state are included as a sub-element in the congestion state table.

Thus, the described aspects can eliminate the inefficient duplication of congestion management state for each connection and provide a solution to determining how a connection or data flow can identify its associated congestion management state and how a scheduler (which schedules packets based on congestion management state) can identify all the connections associated with that connection management state.

### Exemplary Network Architecture

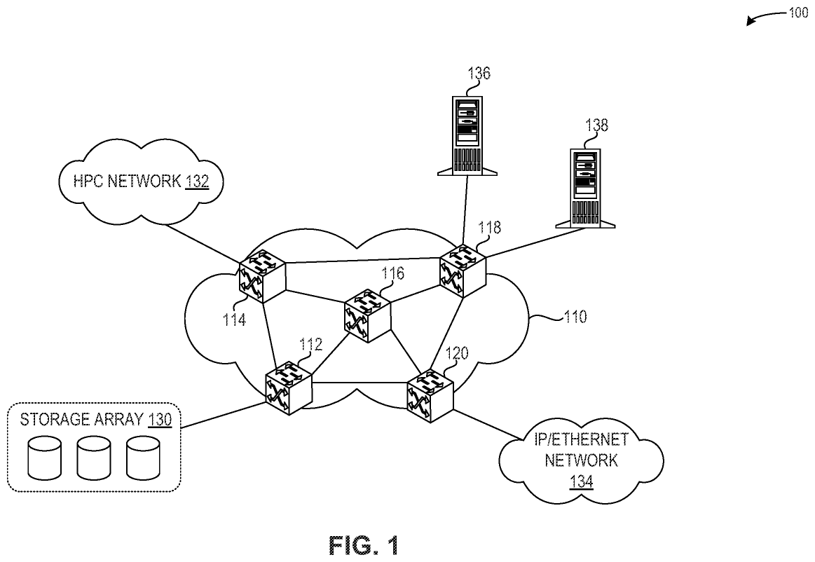

FIG. 1 illustrates a diagram 100 of an exemplary network architecture, in accordance with an aspect of the present application. Diagram 100 can include a network 110 of switches which can be referred to as a “switch fabric” and can include switches 112, 114, 116, 118, and 120. Each switch can have a unique address or identifier within switch fabric 110. Various types of devices and networks can be coupled to a switch fabric. For example, a storage array 130 can be coupled to switch fabric 110 via switch 112; a high performance computing (HPC) network (e.g., InfiniBand, Slingshot, or any other high performance network) 132 can be coupled to switch fabric 110 via switch 114; a number of end hosts, such as hosts 136 and 138, can be coupled to switch fabric 110 via switch 118; and an Internet Protocol (IP)/Ethernet network 134 can be coupled to switch fabric 110 via switch 120. An HPC network can include multiple networked computer and storage devices concurrently running programs to complete different complex and performance-intensive tasks. An IP/Ethernet network can include physical Ethernet cabling and an application layer protocol between network devices based on IP, including communication via Transport Communication Protocol (TCP)/IP and User Datagram Protocol (UDP) packets. In general, a switch can have edge ports and fabric ports. An edge port can couple to a device that is external to the fabric. A fabric port can couple to another switch within the fabric via a fabric link. Typically, traffic can be injected into switch fabric 110 via an ingress port of an edge switch and can leave switch fabric 110 via an egress port of another (or the same) edge switch. An ingress link can couple a NIC of an edge device (for example, an HPC end host) to an ingress edge port of an edge switch. Switch fabric 100 can then transport the traffic to an egress edge switch, which in turn can deliver the traffic to a destination edge device via another NIC.

### First Solution: Indirection Index in Connection State Table to Congestion State Table

When establishing a connection between two network endpoints or NICs (e.g., a first NIC and a second NIC), the first NIC can be the “initiator node” or the “send side” and the second NIC can be the “target node” or the “receive side.” The first NIC can establish the connection with the second NIC by transmitting a control packet which includes a connection identifier (also referred to as a “connection ID” or a “connection_ID”) for the first NIC and a connection ID for the second NIC. Each of a pair of NICs can maintain its own connection state (referred to as the “connection array” or the “connection_array”) and corresponding congestion management state (referred to as the “congestion array” or the “congestion_array”). The network endpoints or NICs described herein can refer to, e.g., switches in network 110 or switch fabric 110 of FIG. 1.

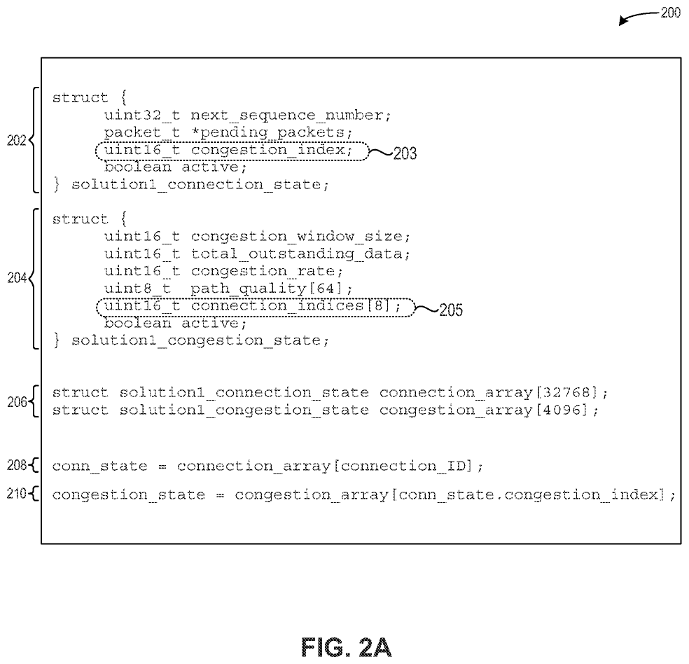

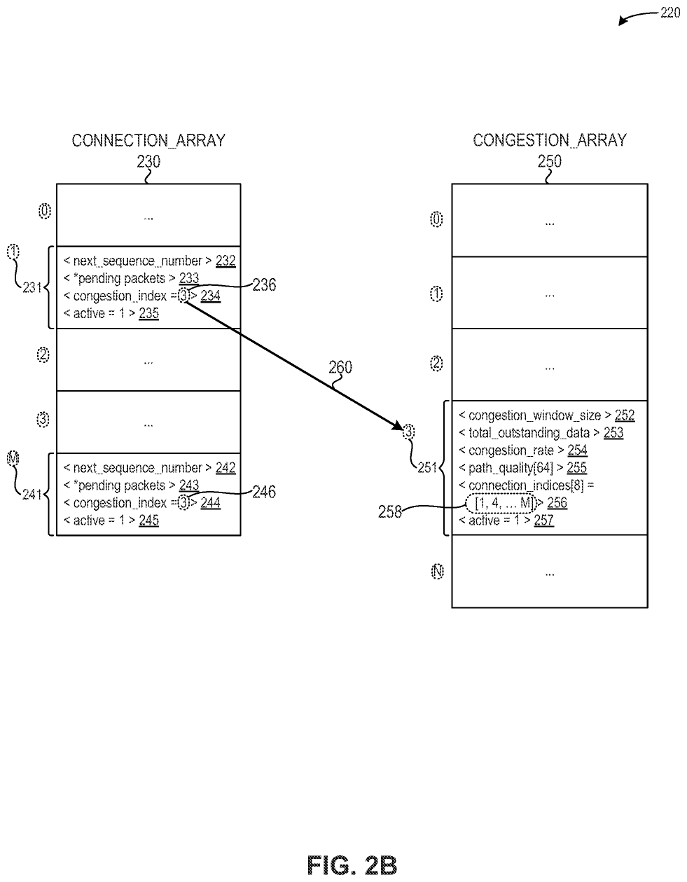

In the first solution, the connection state table can include an “indirection index,” as used herein, an index into the corresponding element of the congestion state table, as described below in relation to FIG. 2A.

FIG. 2A illustrates pseudocode 200 for creating and accessing two data structures for a connection state and a congestion state, based on an indirection index, in accordance with an aspect of the present application. Psuedocode 200 can include sections 202 and 204, which define the data structures or tables for, respectively, the connection_array and the congestion_array. Psuedocode 200 can also include: lines 206 to create the data structures; a line 208 to obtain the connection state for a given connection ID; and a line 210 to identify the corresponding congestion state for the obtained connection state.

Section 202 can represent the definition of a structure of the connection_array using the first solution, referred to as “solution1_connection_state,” where: “next_sequence_number” indicates the next sequence number to be sent (if the structure is on the send side) or that is expected (if the structure is on the receive side); “*pending packets” indicates the packets which are pending to be processed by the given node; “congestion_index” (203) indicates an index of the corresponding entry in the congestion_array; and “active” indicates a status of the connection, e.g., whether the entry is active or inactive.

Section 204 can represent the definition of a structure of the congestion_array using the first solution, referred to as “solution1_congestion_state,” where: “congestion_window_size” indicates the maximum number of packets or bytes that may be sent at one time or prior to receiving an acknowledgment; “total_outstanding_data” indicates the number of packets or bytes of data already sent but not yet acknowledged; “congestion_rate” indicates a maximum rate that the data can move along a path or a total capacity of the path; “path_quality[64]” indicates an ability of the path to transmit data; “connection_indices[8]” (205) indicates an array of connection IDs which correspond to the given congestion_state array; and “active” indicates a status, e.g., whether the entry is active or inactive.

Lines 206 can indicate the following: the connection_array can be defined with e.g., 32768 elements based on the solution1_connection_state data structure defined in 202; and the congestion_array can be defined with, e.g., 4096 elements based on the solution1_congestion_state data structure defined in 204.

The appropriate entry representing the connection state can be obtained by using the connection_ID as the index into the connection_array (as indicated by line 208). Subsequently, the corresponding congestion state can be identified by using the congestion index in the obtained connection state entry as the index into the congestion_array (as indicated by line 210). Lines 208 and 210 demonstrate how the first solution can use the congestion index (203) in the connection_array as the indirection index into the congestion_array.

FIG. 2B illustrates a diagram 220 depicting information stored and accessed in the connection array and the congestion array shown in FIG. 2A, in accordance with an aspect of the present application. Diagram 200 depicts a connection_array 230 with entries at indices 0 to M (indicated with dashed circles), where M can be, e.g., 32768. An entry in connection_array 230 can be as defined in section 202 of FIG. 2A. For example, an entry 231 at an index “1” (i.e., for a connection_ID of “1”) can include the following elements: a “next_sequence_number” 232; a “*pending packets” 233; a “congestion_index” 234 with a value of “3” (as indicated by a label 236); and a status 235 of “active” set to a value of “1,” indicating that the connection state indicated by this entry 231 is active.

Multiple connections may share the same congestion state. For example, an entry 241 at an index “M” (i.e., for a connection_ID of “M”) can include the following elements: a “next_sequence_number” 242; a “*pending packets” 243; a “congestion_index” 244 with a value of “3” (as indicated by a label 246); and a status 245 of “active” set to a value of “1,” indicating that the connection state indicated by this entry 241 is active.

Diagram 220 also depicts a congestion_array 250 with entries at indices 0 to N (indicated with dashed circles), where N can be, e.g., 4096. An entry in congestion_array 250 can be as defined in section 204 of FIG. 2A. For example, an entry 251 at an index “3” can include the following elements: a “congestion_window_size” 252; a “total_outstanding_data” 253; a “congestion_rate” 254; a “path_quality[64]” 255; a “connection_indices[8]” 256 array with a value of “[1, 4, . . . M]” (as indicated by a label 258); and a status 257 of “active” set to a value of “1,” indicating that the congestion management state indicated by this entry 251 is active.

As indicated by congestion_index 234, entry 251 in congestion_array 250 can correspond to entry 231 in connection_array 230 (indicated by an arrow 260). Thus, for a given data flow between an initiator node and target node, the connection_ID (e.g., of the initiator node) can be used to obtain the connection state for a given data flow (e.g., entry 231 in connection_array 230). Upon obtaining the connection state (entry 231), the congestion index (e.g., congestion_index 234 with a value of “3” as indicated by label 236) in the connection state (entry 231) can be used as the index for identifying the corresponding congestion state (e.g., entry 241 with an index of “3” in congestion_array 250).

The obtained connection state and identified congestion management state can be used by a scheduler (which may be scheduling packets based on congestion management) to identify all the connections associated with a given congestion management state. Scheduling can occur over the active congestion array. When an element in the congestion array indicates readiness for scheduling, the scheduler can retrieve the available connections from the congestion array. Acknowledgments sent in response to data transmitted or received can be used to access the connection array to complete one or more pending packets (233). Subsequent to accessing the connection array, the scheduler can use the congestion index to update the congestion array, e.g., the total outstanding data (253).

For example, the scheduler can determine that a certain congestion element is ready for scheduling. After identifying the connection state (entry 231) and the corresponding congestion state (entry 241), the scheduler can check the status of the connection entries at the indices indicated in the “connection_indices[8]” (e.g., element 256 with a value of “[1, 4, . . . , M]” as indicated by label 258). For each of the indices listed in element 256 (i.e., 1, 4, . . . , M), the scheduler can look at the corresponding element in connection_array 230 to determine whether the status is active (e.g., whether the element “active” has as value of “0” for inactive and “1” for active). If the element is active (or has its boolean “active” element set to value of “1”), the scheduler can schedule the pending packets indicated in the given connection state entry.

In the example of diagram 200, the connection_indices for congestion_array entry 251 are listed as “[1, 4, . . . . M],” which indicates to the scheduler to look up the entries at those indices in connection_array 230, check the status, and schedule the pending packets if the status is active. Entry 231 corresponds to index 1 and indicates an active status (235), so the scheduler can schedule pending packets (233) indicated in entry 231 to be processed. Entry 241 corresponds to index M and indicates an active status (245), so the scheduler can schedule the pending packets (243) indicated in entry 241 to be processed. Note that while only the entries for indices 1 and M are depicted in connection_array 230 (and the entry for index 4 is not depicted), the scheduler can look at the active status in each listed index in a similar fashion to determine whether or not to schedule the pending packets indicated in a given entry.

In this first solution, the elements of the congestion array can be dynamically allocated. As part of establishing a connection between the initiator node and the target node, the system can determine whether a congestion array element exists for the target node. If the congestion array element does exist, the system can use that congestion array element. If the congestion array element does not exist, the system can allocate a new element in the congestion array.

Connections may be expected to exist for at least several microseconds. In general, a solution may not be required to establish one connection per cycle. As a result, various data structures can be used to track the allocated congestion state elements and to identify the congestion state elements upon establishing a connection. After the connection is established, accessing the congestion state may be a simple static random access memory (SRAM) access, which can occur at one element per cycle.

In the first solution, a first network endpoint establishes a connection with a second network endpoint by transmitting a control packet including a first identifier associated with the connection and the first network endpoint. The first network endpoint stores, in a first data structure based on the first identifier, a first connection state associated with the connection. The first network endpoint stores, in a second data structure based on the first connection state, a first congestion state associated with the connection. The system identifies, for a data flow associated with the first identifier, a congestion state corresponding to the data flow. Identifying the corresponding congestion state comprises: obtaining the first connection state by searching the first data structure based on the first identifier; and identifying the first congestion state by searching the second data structure based on the obtained first connection state. The first network endpoint stores the first connection state in a first entry in the first data structure, the first data structure comprising connection states associated with connections between the first network endpoint and at least the second network endpoint; and the first network endpoint stores the first congestion state in a second entry in the second data structure, the second data structure comprising congestion states associated with the connections between the first network endpoint and at least the second network endpoint. The first entry indicates at least the first identifier associated with the connection, one or more data packets pending to be transmitted, a first status associated with the connection, and a congestion index associated with the first congestion state stored in the second data structure. The system identifies the first congestion state by searching the second data structure further based on the congestion index indicated in the first entry.

### Second Solution: Encoding a Connection ID to Directly Index the Congestion State Table

In the second solution, an encoding of a connection identifier (ID) can be used to directly index into the congestion state table and to identify the congestion state associated with a connection state. As described above, connection IDs can be used in the network when establishing connections. In general, a packet can include an initiator node (or source) connection ID and a target node (or destination) connection ID. The second solution can leverage these connection IDs to directly index the connection array and the congestion array, thus removing the linkage indices used in the first solution.

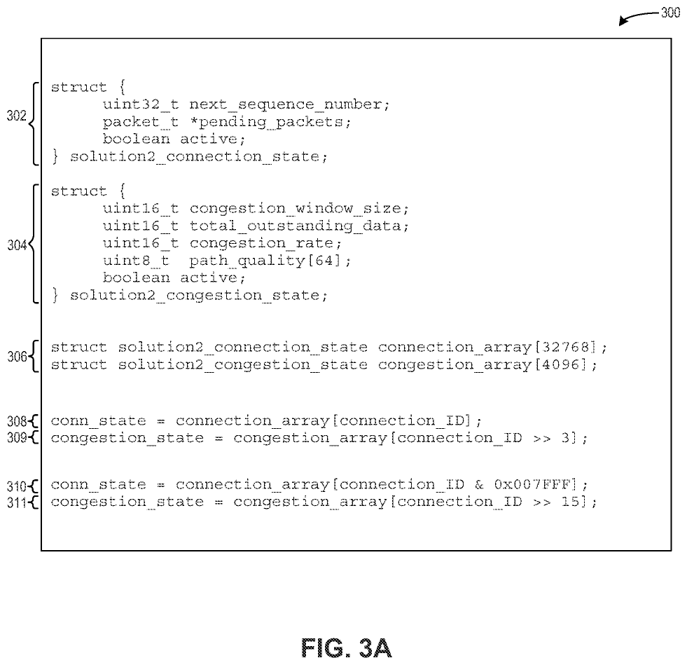

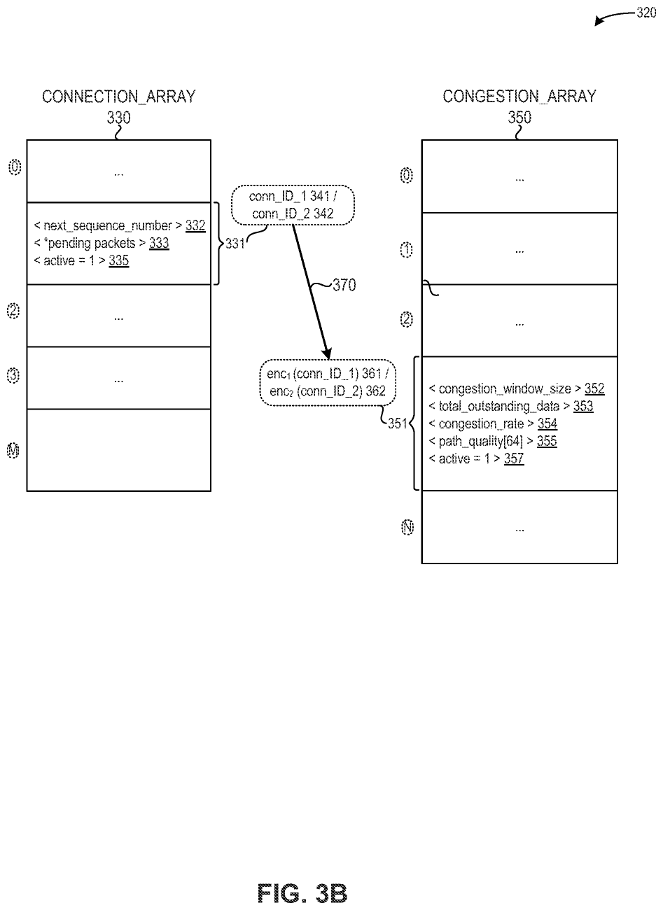

FIG. 3A illustrates pseudocode 300 for creating and accessing two data structures for a connection state and a congestion state, based on an encoding of an identifier, in accordance with an aspect of the present application. Psuedocode 300 can include sections 302 and 304, which define the data structures or tables for, respectively, the connection_array and the congestion_array. Psuedocode 300 can also include: lines 306 to create the data structures; lines 308-309 to obtain the connection state and identify the corresponding congestion state based on a first encoding; and lines 310-311 to obtain the connection state and identify the corresponding congestion state based on a second encoding.

Section 302 can represent the definition of a structure of the connection_array using the second solution, referred to as “solution2_connection_state,” where: “next_sequence_number” indicates the next sequence number to be sent (if the structure is on the send side) or that is expected (if the structure is on the receive side); “*pending packets” indicates the packets which are pending to be processed by the given node; and “active” indicates a status of the connection, e.g., whether the entry is active or inactive.

Section 304 can represent the definition of a structure of the congestion_array using the second solution, referred to as “solution2_congestion_state,” where: “congestion_window_size” indicates the maximum number of packets or bytes that may be sent at one time or prior to receiving an acknowledgment; “total_outstanding_data” indicates the number of packets or bytes of data already sent but not yet acknowledged; “congestion_rate” indicates a maximum rate that the data can move along a path or a total capacity of the path; “path_quality[64]” indicates an ability of the path to transmit data; and “active” indicates a status, e.g., whether the entry is active or inactive.

Lines 306 can indicate the following: the connection_array can be defined with e.g., 32768 elements based on the solution2_connection_state data structure defined in 302; and the congestion_array can be defined with, e.g., 4096 elements based on the solution2_congestion_state data structure defined in 304.

The system can leverage the appropriate connection ID (included in a packet as the initiator connection ID and a target connection ID) to directly index both the connection array and the congestion array. As one example, lines 308-309 indicate how to access the connection state and the corresponding congestion state based on the connection_ID and a first encoding of the connection_ID. The appropriate entry representing the connection state can be obtained by using the connection_ID as a direct index into the connection_array (as indicated by line 308). Subsequently, the corresponding congestion state can be identified by using (instead of the congestion index as in the first solution) an encoding (i.e., the first encoding) of the connection_ID as the index into the congestion_array (as indicated by line 309). The encoding can be, e.g., shifting the connection_ID three bits to the right. In the case where the connection_ID contains 15 bits, the encoded index (in 309) can contain 12 bits, which can result in a maximum amount of overlap between the two indices (i.e., 12 bits in common).

The first encoding of the connection ID indicated in lines 308-309 may represent a contiguous linear space. Other variations, including using data structures of the same size, may also be possible. As another example, lines 310-311 indicate how to access the connection state and the corresponding congestion state based on the connection_ID or a second encoding of the connection_ID. The appropriate entry representing the connection state can be obtained by using certain bits of the connection_ID as the index into the connection_array (as indicated by line 310). Subsequently, the corresponding congestion state can be identified by using (instead of the congestion index as in the first solution) an encoding (i.e., the second encoding) of the connection_ID as the index into the congestion_array (as indicated by line 311). The encoding can be, e.g., isolating or masking the bits out of the connection_ID and using the bottom 15 bits as the index for the connection_array (as indicated by line 310) and using the upper 12 bits as the index for the congestion array (as indicated by line 311). In the case where the connection_ID contains 27 or more bits, the encoded index (in 311) can contain 12 bits, which can result in no amount of overlap between the two indices (i.e., 0 bits in common).

The examples of lines 308-309 and 310-311 are provided for illustrative purposes only. Other variations may be used. That is, any encoding or combination or sequence of encodings of the connection_ID may be used to directly index the relevant portions of one or more of the connection_array and the congestion_array. By using such an encoding, the lookups performed by the system (e.g., the scheduler) do not need to be serialized and may be performed concurrently.

FIG. 3B illustrates a diagram 320 depicting information stored and accessed in the connection array and the congestion array shown in FIG. 3A, in accordance with an aspect of the present application. Diagram 320 depicts a connection_array 330 with entries at indices 0 to M (indicated by dashed circles), where M can be, e.g., 32768. An entry in connection_array 330 can be as defined in section 302 of FIG. 3A. For example, an entry 331 can include the following elements: a “next_sequence_number” 332; a “*pending packets” 333; and a status 335 of “active” set to a value of “1,” indicating that the connection state indicated by this entry 331 is active.

Diagram 320 also depicts a congestion_array 350 with entries at indices 0 to N (indicated with dashed circles), where N can be, e.g., 4096. An entry in congestion_array 350 can be as defined in section 304 of FIG. 3A. For example, an entry 351 can include the following elements: a “congestion_window_size” 352; a “total_outstanding_data” 353; a “congestion_rate” 354; a “path_quality[64]” 355; and a status 357 of “active” set to a value of “1,” indicating that the congestion management state indicated by this entry 351 is active.

The index for entry 331 in connection_array 330 can be, e.g., “conn_ID_1” 341 (as indicated by line 308 of FIG. 3A). The system can apply a first encoding to index 341 to obtain the corresponding index “enc₁ (conn_ID_1)” 361 in congestion_array 350 (as indicated by line 309 of FIG. 3A). The lookup and retrieval of the corresponding congestion state from the connection state can be indicated by an arrow 370.

The system can also apply a different encoding to the connection ID. The index for entry 331 in connection_array 330 can be, e.g., “conn_ID_2” 342, and index 342 may itself be encoded (as indicated by line 310 of FIG. 3A). The system can apply a second encoding to index 342 to obtain the corresponding index “enc₂ (conn_ID_2)” 362 in congestion_array 350 (as indicated by line 311 of FIG. 3A). The lookup and retrieval of the corresponding congestion state from the connection state can be indicated by arrow 370.

In some aspects, only two types of data flows may be multiplexed onto a single congestion state. The first type of data flow can include requests (including requests with data) and the second type of data flow can include responses with data. For example, a first network endpoint (“A”) may transmit data to a second network endpoint (“B”) (as the first type of data flow), and the first network endpoint may also transmit data to the second network endpoint in response to a request for data from the second network endpoint. In such cases, the system can use a portion of the connection identifier (e.g., one bit) to distinguish between the first type of data flow (e.g., requests) and the second type of data (e.g., responses). That is, the first network endpoint can store the connection state (for requests from A to B) in a data structure which includes connection states associated with the first network endpoint as a transmitting entity (e.g., a “send” connection array), using an index which a portion of the connection identifier, e.g., the connection identifier shifted right by one bit or an upper or lower portion of the connection identifier. The first network endpoint can also store the connection state (for responses from A to B) in another data structure which includes connection states associated with the first network endpoint as a receiving entity (e.g., a “receive” connection array), using the same index portion. The same index portion can be used to index into the congestion array. A remainder of the connection identifier (e.g., one bit) can be used to identify whether the data flow is of the first type (request) or the second type (response), and the corresponding congestion state can be stored and accessed in the congestion array based on that remainder (e.g., one bit).

In the second solution, a first network endpoint establishes a connection with a second network endpoint by transmitting a control packet including a first identifier associated with the connection and the first network endpoint. The first network endpoint stores, in a first data structure based on the first identifier, a first connection state associated with the connection. The first network endpoint stores, in a second data structure based on the first connection state, a first congestion state associated with the connection. The system identifies, for a data flow associated with the first identifier, a congestion state corresponding to the data flow. Identifying the corresponding congestion state comprises: obtaining the first connection state by searching the first data structure based on the first identifier; and identifying the first congestion state by searching the second data structure based on the obtained first connection state. The first network endpoint stores the first connection state in a first entry in the first data structure, the first data structure comprising connection states associated with connections between the first network endpoint and at least the second network endpoint; and the first network endpoint stores the first congestion state in a second entry in the second data structure, the second data structure comprising congestion states associated with the connections between the first network endpoint and at least the second network endpoint. The first entry in the first data structure indicates at least the first identifier associated with the connection, one or more data packets pending to be transmitted, and a first status associated with the connection, and the second entry in the second data structure indicates at least a second status associated with the first congestion state and one or more of a congestion window size and a congestion rate. The system identifies the first congestion state by searching the second data structure further based on an encoding associated with the first identifier

### Third Solution: Encoding a Connection ID to Directly Index the Congestion State Table and Embedding Connection State in Congestion State

In the third solution, which is based on the second solution, the encoding can be used to directly index into the congestion state, where corresponding connection states for the congestion state can be included as a sub-element in the congestion state table. The size of the congestion management state may dominate the size of the storage, e.g., because the measures of path quality (64 bytes) may be large in comparison to the other elements of the congestion array. As a result, a single congestion state entry can embed or include multiple states of connection state, i.e., by including the corresponding connection states as a sub-element in the congestion array.

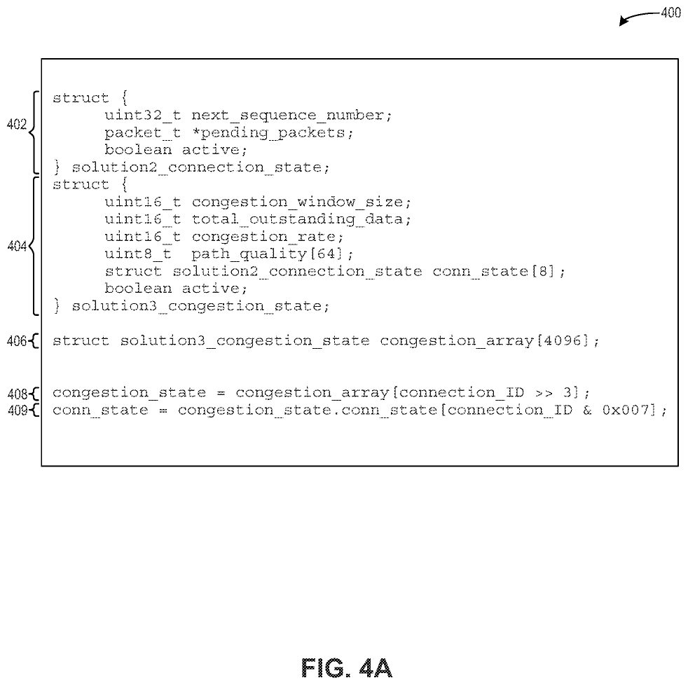

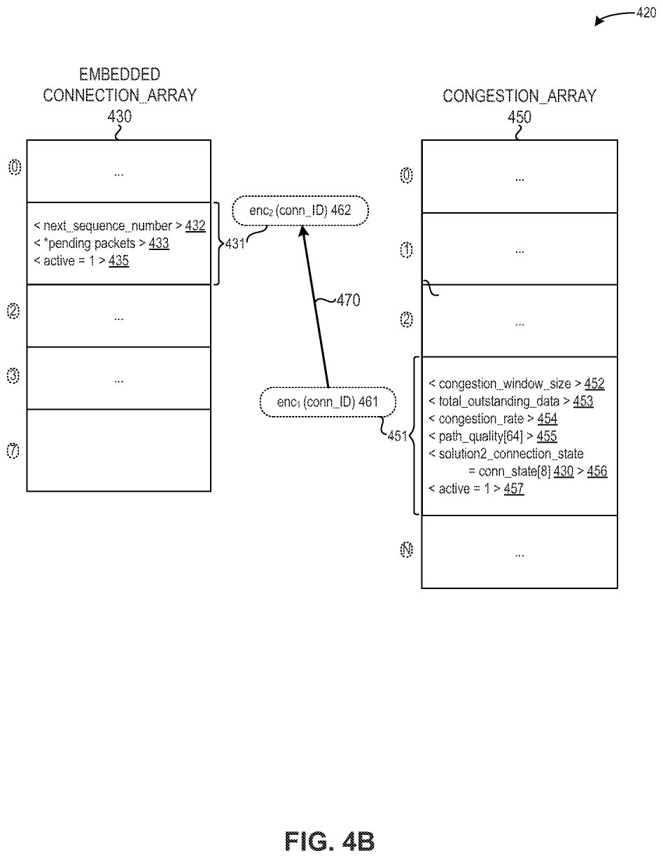

FIG. 4A illustrates pseudocode 400 for creating and accessing two data structures for a connection state and a congestion state, based on an encoding of an identifier and including multiple connection states embedded in the congestion state, in accordance with an aspect of the present application. Psuedocode 400 can include sections 402 and 404, which define the data structures or tables for, respectively, the connection_array and the congestion_array. Psuedocode 400 can also include: line 406 to create the single congestion_state data structure; and lines 408-409 to identify the congestion state and obtain the corresponding connection state based on an encoding.

Section 402 can represent the definition of a structure of the connection_array using the third solution, referred to as “solution3_connection_state,” where: “next_sequence_number” indicates the next sequence number to be sent (if the structure is on the send side) or that is expected (if the structure is on the receive side); “*pending packets” indicates the packets which are pending to be processed by the given node; and “active” indicates a status of the connection, e.g., whether the entry is active or inactive.

Section 404 can represent the definition of a structure of the congestion_array using the third solution, referred to as “solution3_congestion_state,” where: “congestion_window_size” indicates the maximum number of packets or bytes that may be sent at one time or prior to receiving an acknowledgment; “total_outstanding_data” indicates the number of packets or bytes of data already sent but not yet acknowledged; “congestion_rate” indicates a maximum rate that the data can move along a path or a total capacity of the path; “path_quality[64]” indicates an ability of the path to transmit data; “conn_state[8]” indicates an array of structures of “solution2_connection_state”; and “active” indicates a status, e.g., whether the entry is active or inactive.

Line 406 can indicate that the congestion_array can be defined with, e.g., 4096 elements based on the “solution3_congestion_state” data structure defined in 404. As described above, the “solution3_congestion_state” data structure contains multiple connection state entries (depicted as up to 8 connection state entries for illustrative purposes only). That is, the connection state information can be embedded in the congestion state entry, and the connection state can be a sub-element of the congestion state.

As a result, lines 408-409 indicate how to identify and obtain the congestion state and the connection state. Because the third solution is based on the use of only one data structure (the congestion array), the appropriate entry representing the congestion state can be identified by using an encoding of the connection_ID, e.g., shifting the connection_ID three bits to the right (as indicated by line 408). Subsequently, the corresponding connection state can be obtained by masking off and selecting the lower three bits of the connection_ID (as indicated by line 409). In this example, the index into the connection array sub-element may comprise three bits to cover the up-to-eight entries in the connection array (as defined in section 404).

Thus, while the third solution performs the lookups to obtain and identify the connection and congestion information in a reverse order than the second solution, both the second and third solutions can achieve access in a single lookup by parsing the data in the lookup, as described in relation to diagrams 3B and 4B.

FIG. 4B illustrates a diagram 420 depicting information stored and accessed in the connection array and the congestion array shown in FIG. 4A, in accordance with an aspect of the present application. Diagram 420 depicts an embedded connection_array 430 with eight entries at indices 0 to 7 (indicated with dashed circles). An entry in embedded connection_array 430 can be as defined in sections 302 and 402 of FIGS. 3A and 4A. For example, an entry 431 can include the following elements: a “next_sequence_number” 432; a “*pending packets” 433; and a status 435 of “active” set to a value of “1,” indicating that the connection state indicated by this entry 431 is active.

Diagram 420 also depicts a congestion_array 450, into which an array of connection_arrays (such as embedded connection_array 430) can be embedded. Congestion_array 450 can include entries at indices 0 to N (indicated with dashed circles), where N can be, e.g., 4096. An entry in congestion_array 450 can be as defined in section 404 of FIG. 4A. For example, an entry 451 can include the following elements: a “congestion_window_size” 452; a “total_outstanding_data” 453; a “congestion_rate” 454; a “path_quality[64]” 455; an array of “solution2_connection_state” arrays 456, each defined as a “conn_state[8]” (e.g., embedded connection_array 430); and a status 457 of “active” set to a value of “1,” indicating that the congestion management state indicated by this entry 451 is active.

The system can apply a first encoding to the connection_ID to determine the index for entry 451 in congestion_array 450, to identify the congestion state, e.g., “enc₁ (conn_ID)” 461 (as indicated by line 408 of FIG. 4A). Upon identifying entry 451, the system can apply a second encoding to the connection_ID to obtain the corresponding index “enc₂ (conn_ID)” 462 in the embedded congestion_array 430 (sub-element 456 of entry 451) (as indicated by line 409 of FIG. 4A). The lookup and retrieval of the corresponding connection state based on the identified congestion state can be indicated by an arrow 470.

The elements in the structures of sections 202, 204, 302, 304, 402, and 404 are depicted for illustrative purposes only. Sections 202, 204, 302, 304, 402, and 404 may include fewer or more elements than as depicted and may include one or more of the depicted elements or any combination of the depicted elements.

Similar to the second solution, in the third solution, a first network endpoint establishes a connection with a second network endpoint by transmitting a control packet including a first identifier associated with the connection and the first network endpoint. The first network endpoint stores, in a first data structure based on the first identifier, a first connection state associated with the connection. The first network endpoint stores, in a second data structure based on the first connection state, a first congestion state associated with the connection. The system identifies, for a data flow associated with the first identifier, a congestion state corresponding to the data flow. Identifying the corresponding congestion state comprises: obtaining the first connection state by searching the first data structure based on the first identifier; and identifying the first congestion state by searching the second data structure based on the obtained first connection state. The first network endpoint stores the first connection state in a first entry in the first data structure, the first data structure comprising connection states associated with connections between the first network endpoint and at least the second network endpoint; and the first network endpoint stores the first congestion state in a second entry in the second data structure, the second data structure comprising congestion states associated with the connections between the first network endpoint and at least the second network endpoint. The first entry in the first data structure indicates at least the first identifier associated with the connection, one or more data packets pending to be transmitted, and a first status associated with the connection, and the second entry in the second data structure indicates at least a second status associated with the first congestion state and one or more of a congestion window size and a congestion rate. The system identifies the first congestion state by searching the second data structure further based on an encoding associated with the first identifier.

In addition, in the third solution, the second entry in the second data structure further indicates an array comprising connection state entries from the first data structure, the second entry comprising the first congestion state. The first network endpoint includes the connection states associated with the connection as a sub-element of the congestion state. The system identifies the first congestion state by searching the second data structure further based on a first encoding associated with the first identifier and the system obtains the first connection state by searching the array based on a second encoding associated with the first identifier.

### Method Which Facilitates Decoupling Congestion Management and Connection State in a NIC

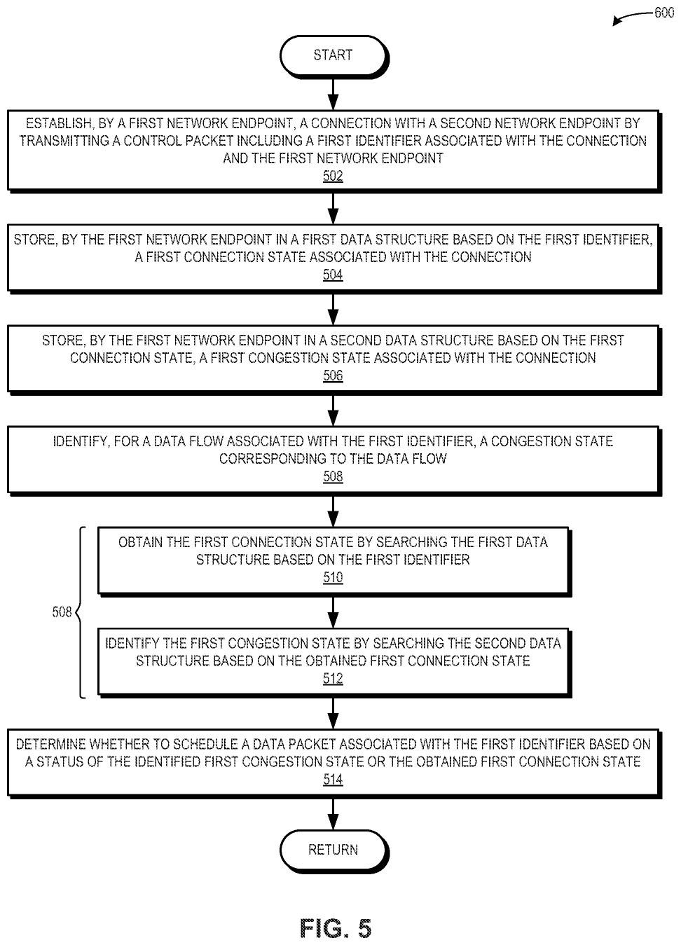

FIG. 5 presents a flowchart 500 illustrating a method which facilitates decoupling congestion management and connection state in a NIC, in accordance with an aspect of the present application. During operation, the system establishes, by a first network endpoint, a connection with a second network endpoint by transmitting a control packet including a first identifier associated with the connection and the first network endpoint (operation 502). The first identifier can be, e.g., a connection ID used in the network when establishing connections. As described above, a packet can include an initiator node (or source) connection ID and a target node (or destination) connection ID. In the first solution, the connection ID can be used to directly index the connection array while an indirection index can be used to access the congestion array. In the second and third solutions, the connection ID can be leveraged (e.g., based on one or more encodings) to directly index into both the connection and congestion arrays.

The system stores, by the first network endpoint in a first data structure based on the first identifier, a first connection state associated with the connection (operation 504). The first connection state can be stored in a first entry in the first data structure, and the first data structure can include connection states associated with connections between the first network endpoint and at least the second network endpoint, as described above in relation to data structure 202 (“solution1_connection_state”) of FIG. 2A and entries 231 and 241 of FIG. 2B. The system stores, by the first network endpoint in a second data structure based on the first connection state, a first congestion state associated with the connection (operation 506). The first congestion state can be stored in a second entry in the second data structure, and the second data structure can include congestion states associated with the connections between the first network endpoint and at least the second network endpoint, as described above in relation to data structure 204 (“solution1_congestion_state”) of FIG. 2A and entry 251 of FIG. 2B.

The system identifies, for a data flow associated with the first identifier, a congestion state corresponding to the data flow (operation 508). Operation 508 can include the steps of operations 510 and 512. That is, the system identifies the corresponding congestion state by: obtaining the first connection state by searching the first data structure based on the first identifier (operation 510); and identifying the first congestion state by searching the second data structure based on the obtained first connection state (operation 512). For example, as described above in FIG. 2B, the system can use the connection ID to search connection_array 230, which results in obtaining obtain connection state entry 231, including congestion_index 234. The system can subsequently use the obtained congestion_index 234 to search congestion_array 250, which results in identifying congestion state entry 251. Furthermore, the system determines whether to schedule a data packet associated with the first identifier based on a status of the identified first congestion state or the obtained first connection state (operation 514). For example, a scheduler or scheduling component can use the value of the status 257 element in congestion_array 250 of FIG. s2B or the value of the status 235 element in connection_array 230 of FIG. 2B to determine whether to schedule the corresponding packet. The value of elements 235/257 may indicate “inactive” set to a value of “0” or “active” set to a value of “0,” as described above in relation to FIG. 2B and as similarly described above for elements 335/357 of FIG. 3B and elements 435/457 of FIG. 4B. The scheduler or scheduling component may use these values as part of a scheduling algorithm to determine the order in which to schedule the corresponding packets.

### Computer System Which Facilitates Decoupling Congestion Management and Connection State in a NIC

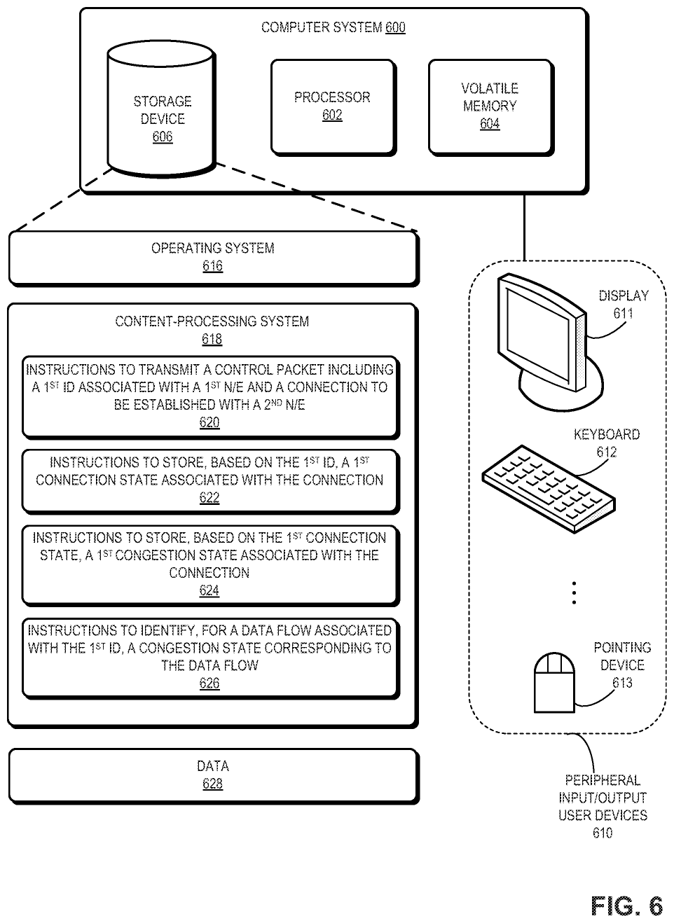

FIG. 6 illustrates a computer system 600 which facilitates decoupling congestion management and connection state in a NIC, in accordance with an aspect of the present application. Computer system 600 includes a processor 602, a memory 604, and a storage device 606. Memory 604 can include a volatile memory (e.g., random access memory (RAM)) that serves as a managed memory and can be used to store one or more memory pools. Furthermore, computer system 600 can be coupled to peripheral I/O user devices 610 (e.g., a display device 611, a keyboard 612, and a pointing device 613). Storage device 606 includes non-transitory computer-readable storage medium and stores an operating system 616, a content-processing system 618, and data 632. Computer system 600 may include fewer or more entities or instructions than those shown in FIG. 6.

Content-processing system 618 of storage device 606 can include instructions which, when executed by computer system 600 (e.g., by a processing resource of computer system 600, such as processor 602), can cause computer system 600 to perform methods and/or processes described in this disclosure. Specifically, content-processing system 618 may include instructions 620 to transmit, by a first network endpoint, a control packet including a first identifier (ID) associated with the first network endpoint (N/E) and a connection to be established with a second network endpoint (N/E). Content-processing system 618 may include instructions 622 to store, by the first network endpoint based on the first identifier, a first connection state associated with the connection. Content-processing system 618 may also include instructions 624 to store, by the first network endpoint based on the first connection state, a first congestion state associated with the connection. Content-processing system 618 may include instructions 626 to identify, for a data flow associated with the first identifier, a congestion state corresponding to the data flow, e.g., by performing: a first search, using the first identifier, in a first structure which stores connection states associated with connections, the first search returning the first connection state; and a second search, using the returned first connection state, in a second data structure which stores congestion states associated with connection states, the second search identifying the first congestion state.

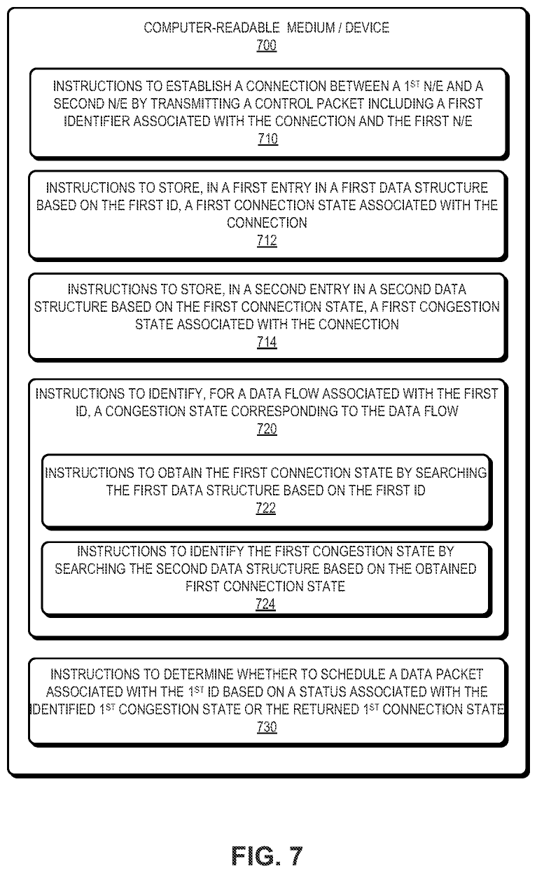

Content-processing system 618 may include fewer or more instructions than those shown in FIG. 6. For example, content-processing system 618 can also store instructions for executing the operations described above in relation to: storing and accessing the arrays of FIGS. 2B, 3B, and 4B; the operations depicted in flowchart 500 of FIG. 5; and the instructions of computer-readable storage medium/device 700 of FIG. 7. Content-processing system 618 can also store instructions to perform the operations associated with using any of the three above-described solutions in relation to, respectively, FIGS. 2A-B (for the first solution), FIGS. 3A-B (for the second solution), and FIGS. 4A-B (for the third solution).

Data 628 can include any data that is required as input or that is generated as output by the methods, operations, communications, and/or processes described in this disclosure. Specifically, data 628 can store at least: a request; an identifier; a connection identifier; an identifier of a network endpoint; an array; a table; a data structure; an entry in a data structure; a packet; a data flow; a connection state; a congestion management state or a congestion state; a connection array; a congestion array; a status; a determination of whether to schedule a packet; an index; a congestion index; an indirection index; an array of connection indices; an embedded array or data structure; an encoding; a number of bits; and an encoding of a number of bits.

FIG. 7 illustrates a computer-readable medium/device 700 which facilitates decoupling congestion management and connection state in a NIC, in accordance with an aspect of the present application. Device 700 can be a non-transitory computer-readable medium storing instructions that when executed by a computer cause the computer to perform a method. Device 700 can store instructions 710 to establish a connection between a first network endpoint (N/E) and a second network endpoint (N/E) by transmitting a control packet including a first identifier associated with the connection and the first network endpoint. Device 700 can store instructions 712 to store, in a first entry in a first data structure based on the first identifier, a first connection state associated with the connection. Device 700 can store instructions 714 to store, in a second entry in a second data structure based on the first connection state, a first congestion state associated with the connection.

Device 700 can further store instructions 720 to identify, for a data flow associated with the first identifier, a congestion state corresponding to the data flow. Instructions 720 can include: instructions 722 to obtain the first connection state by searching the first data structure based on the first identifier; and instructions 724 to identify the first congestion state by searching the second data structure based on the obtained first connection state. Device 700 can also store instructions 730 to determine whether to schedule a data packet associated with the first identifier based on a status of the identified first congestion state or the returned first connection state.

Device 700 may include more instructions than those shown in FIG. 7. For example, device 700 can also store instructions for executing the operations described above in relation to: storing and accessing the arrays of FIGS. 2B, 3B, and 4B; the operations depicted in flowchart 500 of FIG. 5; and the instructions of content-processing system 618 in FIG. 6. Device 700 can also store instructions to perform the operations associated with using any of the three above-described solutions in relation to, respectively, FIGS. 2A-B (for the first solution), FIGS. 3A-B (for the second solution), and FIGS. 4A-B (for the third solution).

### Various Aspects

In general, the disclosed aspects provide a method, computer system, and non-transitory computer-readable storage medium for decoupling congestion management and connection state in an HPC environment (e.g., in network endpoints or NICs). In one aspect, the system establishes, by a first network endpoint, a connection with a second network endpoint by transmitting a control packet including a first identifier associated with the connection and the first network endpoint. The system stores, by the first network endpoint in a first data structure based on the first identifier, a first connection state associated with the connection. The system stores, by the first network endpoint in a second data structure based on the first connection state, a first congestion state associated with the connection. The system identifies, for a data flow associated with the first identifier, a congestion state corresponding to the data flow. Identifying the corresponding congestion state comprises: obtaining the first connection state by searching the first data structure based on the first identifier; and identifying the first congestion state by searching the second data structure based on the obtained first connection state.

In a variation on this aspect, the system identifies a data packet to be scheduled. The data packet is associated with the first identifier. The system determines whether to schedule the data packet based on at least one of: a status of the identified first congestion state; a status of the obtained first connection state; or one or more statuses of connections associated with the identified first congestion state.

In a further variation on this aspect, the system stores the first connection state in a first entry in the first data structure. The first data structure comprises connection states associated with connections between the first network endpoint and at least the second network endpoint. The system stores the first congestion state in a second entry in the second data structure. The second data structure comprises congestion states associated with the connections between the first network endpoint and at least the second network endpoint.

In yet another variation on this aspect, the first entry indicates at least the first identifier associated with the connection, one or more data packets pending to be transmitted, a first status associated with the connection, and a congestion index associated with the first congestion state stored in the second data structure. The system identifies the first congestion state by searching the second data structure further based on the congestion index indicated in the first entry.

In another variation, the second entry in the second data structure indicates at least a second status associated with the first congestion state, one or more connection indices corresponding to elements in the first data structure, and one or more of a congestion window size and a congestion rate. The connection indices include at least the first identifier for the connection and correspond to connections associated with the first congestion state.

In another variation, the first entry in the first data structure indicates at least the first identifier associated with the connection, one or more data packets pending to be transmitted, and a first status associated with the connection. The second entry in the second data structure indicates at least a second status associated with the first congestion state and one or more of a congestion window size and a congestion rate. The system identifies the first congestion state by searching the second data structure further based on an encoding associated with the first identifier.

In another variation, the second entry in the second data structure further indicates an array comprising connection state entries from the first data structure, the second entry comprising the first congestion state. The system includes the connection states associated with the connection as a sub-element of the congestion state. The system identifies the first congestion state by searching the second data structure further based on a first encoding associated with the first identifier. The system obtains the first connection state by searching the array based on a second encoding associated with the first identifier.

In another variation, the system encodes the first identifier based on at least one of: obtaining a first index for the second data structure by shifting one or more bits of the first identifier, the first identifier and the first index comprising fully overlapping bits; obtaining a second index for the second data structure by shifting one or more bits of the first identifier, the first identifier and the second index comprising no overlapping bits; or obtaining the first index or the second index by masking the first identifier prior to shifting the one or more bits.

In a further variation, the system determines that the data flow comprises at least: first data transmitted from the first network endpoint to the second network endpoint; and second data transmitted from the first network endpoint to the second network endpoint in response to a request from the second network endpoint. The system stores, by the first network endpoint, the first connection state in the first data structure using a portion of the first identifier in response to the data flow comprising the first data, the first data structure further comprising connection states associated with the first network endpoint as a transmitting entity. The system stores, by the first network endpoint, the first connection state in a third data structure using the same portion of the first identifier in response to the data flow comprising the second data, the third data structure comprising connection states associated with the first network endpoint as a receiving entity. The system stores, by the first network endpoint, the first congestion state in the second data structure using a remainder of the first identifier.

Another aspect provides a computer system comprising a processing resource and a non-transitory computer-readable storage device storing instructions executable by the processing resource to: transmit, by a first network endpoint, a control packet including a first identifier associated with the first network endpoint and a connection to be established with a second network endpoint; store, by the first network endpoint based on the first identifier, a first connection state associated with the connection; store, by the first network endpoint based on the first connection state, a first congestion state associated with the connection; and identify, for a data flow associated with the first identifier, a congestion state corresponding to the data flow, by performing: a first search, using the first identifier, in a first structure which stores connection states associated with connections, the first search returning the first connection state; and a second search, using the returned first connection state, in a second data structure which stores congestion states associated with connection states, the second search identifying the first congestion state. The instructions executable by the processing resource can further include: instructions to store and access the arrays of FIGS. 2B, 3B, and 4B; the operations depicted in flowchart 500 of FIG. 5; and the instructions of computer-readable storage medium/device 700 of FIG. 7.

Yet another aspect provides a non-transitory computer-readable storage medium comprising instructions executable by a processing resource to: establish a connection between a first network endpoint and a second network endpoint by transmitting a control packet including a first identifier associated with the connection and the first network endpoint; store, in a first entry in a first data structure based on the first identifier, a first connection state associated with the connection; store, in a second entry in a second data structure based on the first connection state, a first congestion state associated with the connection; identify, for a data flow associated with the first identifier, a congestion state corresponding to the data flow, by: obtaining the first connection state by searching the first data structure based on the first identifier; and identifying the first congestion state by searching the second data structure based on the obtained first connection state; and determine whether to schedule a data packet associated with the first identifier based on a status of the identified first congestion state or the returned first connection state. The instructions executable by the processing resource can further include: instructions to store and access the arrays of FIGS. 2B, 3B, and 4B; the operations depicted in flowchart 500 of FIG. 5; and the instructions of content-processing system 618 of FIG. 6.

The foregoing descriptions of aspects have been presented for purposes of illustration and description only. They are not intended to be exhaustive or to limit the aspects described herein to the forms disclosed. Accordingly, many modifications and variations will be apparent to practitioners skilled in the art. Additionally, the above disclosure is not intended to limit the aspects described herein. The scope of the aspects described herein is defined by the appended claims.

What is claimed is:

1. A computer-implemented method, comprising:
establishing, by a first network endpoint, a connection with a second network endpoint by transmitting a control packet including a first identifier associated with the connection and the first network endpoint;
storing, by the first network endpoint in a first data structure based on the first identifier, a first connection state associated with the connection;
storing, by the first network endpoint in a second data structure based on the first connection state, a first congestion state associated with the connection; and
identifying, for a data flow associated with the first identifier, a congestion state corresponding to the data flow, identifying the corresponding congestion state comprising:
obtaining the first connection state by searching the first data structure based on the first identifier; and
identifying the first congestion state by searching the second data structure based on the obtained first connection state.

2. The method of claim 1, further comprising:
identifying a data packet to be scheduled, the data packet associated with the first identifier; and
determining whether to schedule the data packet based on at least one of:
a status of the identified first congestion state;
a status of the obtained first connection state; or
one or more statuses of connections associated with the identified first congestion state.

3. The method of claim 1, further comprising:
storing the first connection state in a first entry in the first data structure, the first data structure comprising connection states associated with connections between the first network endpoint and at least the second network endpoint; and
storing the first congestion state in a second entry in the second data structure, the second data structure comprising congestion states associated with the connections between the first network endpoint and at least the second network endpoint.

4. The method of claim 3,
the first entry indicating at least the first identifier associated with the connection, one or more data packets pending to be transmitted, a first status associated with the connection, and a congestion index associated with the first congestion state stored in the second data structure, and
the method further comprising identifying the first congestion state by searching the second data structure further based on the congestion index indicated in the first entry.

5. The method of claim 4,
the second entry in the second data structure indicating at least a second status associated with the first congestion state, one or more connection indices corresponding to elements in the first data structure, and one or more of a congestion window size and a congestion rate, and
the connection indices including at least the first identifier for the connection and corresponding to connections associated with the first congestion state.

6. The method of claim 3,
the first entry in the first data structure indicating at least the first identifier associated with the connection, one or more data packets pending to be transmitted, and a first status associated with the connection,
the second entry in the second data structure indicating at least a second status associated with the first congestion state and one or more of a congestion window size and a congestion rate, and
the method further comprising identifying the first congestion state by searching the second data structure further based on an encoding associated with the first identifier.

7. The method of claim 6,
the second entry in the second data structure further indicating an array comprising connection state entries from the first data structure, the second entry comprising the first congestion state, and
the method further comprising:
including the connection states associated with the connection as a sub-element of the congestion state;
identifying the first congestion state by searching the second data structure further based on a first encoding associated with the first identifier; and
obtaining the first connection state by searching the array based on a second encoding associated with the first identifier.

8. The method of claim 7, further comprising encoding the first identifier based on at least one of:
obtaining a first index for the second data structure by shifting one or more bits of the first identifier, the first identifier and the first index comprising fully overlapping bits;
obtaining a second index for the second data structure by shifting one or more bits of the first identifier, the first identifier and the second index comprising no overlapping bits; or
obtaining the first index or the second index by masking the first identifier prior to shifting the one or more bits.

9. The method of claim 7, further comprising:
determining that the data flow comprises at least:
first data transmitted from the first network endpoint to the second network endpoint; and
second data transmitted from the first network endpoint to the second network endpoint in response to a request from the second network endpoint;
storing, by the first network endpoint, the first connection state in the first data structure using a portion of the first identifier in response to the data flow comprising the first data, the first data structure further comprising connection states associated with the first network endpoint as a transmitting entity;
storing, by the first network endpoint, the first connection state in a third data structure using the same portion of the first identifier in response to the data flow comprising the second data, the third data structure comprising connection states associated with the first network endpoint as a receiving entity; and
storing, by the first network endpoint, the first congestion state in the second data structure using a remainder of the first identifier.

10. A computer system, comprising:
a processing resource; and
a non-transitory machine-readable storage device storing instructions executable by the processing resource to:
transmit, by a first network endpoint, a control packet including a first identifier associated with the first network endpoint and a connection to be established with a second network endpoint;
store, by the first network endpoint based on the first identifier, a first connection state associated with the connection;
store, by the first network endpoint based on the first connection state, a first congestion state associated with the connection; and
identify, for a data flow associated with the first identifier, a congestion state corresponding to the data flow, by performing:
a first search, using the first identifier, in a first structure which stores connection states associated with connections, the first search returning the first connection state; and
a second search, using the returned first connection state, in a second data structure which stores congestion states associated with connection states, the second search identifying the first congestion state.

11. The computer system of claim 10, the instructions executable by the processing resource further to:
determine whether to schedule a data packet associated with the first identifier based on at least one of:
a status of the identified first congestion state;
a status of the returned first connection state; or
one or more statuses of connections associated with the identified first congestion state.

12. The computer system of claim 10, the instructions executable by the processing resource further to:
store the first connection state in a first entry in the first data structure, the first data structure comprising connection states associated with connections between the first network endpoint and at least the second network endpoint; and
store the first congestion state in a second entry in the second data structure, the second data structure comprising congestion states associated with the connections between the first network endpoint and at least the second network endpoint.

13. The computer system of claim 12, the instructions executable by the processing resource further to:
indicate, in the first entry in the first data structure, at least the first identifier associated with the connection, one or more data packets pending to be transmitted, a first status associated with the connection, and a congestion index associated with the first congestion state stored in the second data structure; and
perform the second search based on the congestion index indicated in the first entry.

14. The computer system of claim 13, the instructions executable by the processing resource further to:
indicate, in the second entry in the second data structure, at least a second status associated with the first congestion state, one or more connection indices corresponding to elements in the first data structure, and one or more of a congestion window size and a congestion rate; and
include in the connection indices at least the first identifier for the connection, the connection indices corresponding to connections associated with the first congestion state.

15. The computer system of claim 12, the instructions executable by the processing resource further to:
indicate, in the first entry in the first data structure, at least the first identifier associated with the connection, one or more data packets pending to be transmitted, and a first status associated with the connection;
indicate, in the second entry in the second data structure, at least a second status associated with the first congestion state and one or more of a congestion window size and a congestion rate; and
perform the second search based on an encoding associated with the first identifier.

16. The computer system of claim 15, the instructions executable by the processing resource further to:
indicate, in the second entry in the second data structure, an array comprising connection state entries from the first data structure, the second entry comprising the first congestion state;
include the connection states associated with the connection as a sub-element of the congestion state;
identify the first congestion state by searching the second data structure based on a first encoding associated with the first identifier; and
obtaining the first connection state by searching the array based on a second encoding associated with the first identifier.

17. The computer system of claim 16, the instructions executable by the processing resource further to encode the first identifier by at least one of:
obtaining a first index for the second data structure by shifting one or more bits of the first identifier, the first identifier and the first index comprising fully overlapping bits;
obtaining a second index for the second data structure by shifting one or more bits of the first identifier, the first identifier and the second index comprising no overlapping bits; or
obtaining the first index or the second index by masking the first identifier prior to shifting the one or more bits.

18. A non-transitory computer-readable storage medium comprising instructions executable by a processing resource to:
establish a connection between a first network endpoint and a second network endpoint by transmitting a control packet including a first identifier associated with the connection and the first network endpoint;
store, in a first entry in a first data structure based on the first identifier, a first connection state associated with the connection;
store, in a second entry in a second data structure based on the first connection state, a first congestion state associated with the connection;
identify, for a data flow associated with the first identifier, a congestion state corresponding to the data flow, by:
obtaining the first connection state by searching the first data structure based on the first identifier; and
identifying the first congestion state by searching the second data structure based on the obtained first connection state; and
determine whether to schedule a data packet associated with the first identifier based on a status of the identified first congestion state or the returned first connection state.

19. The non-transitory computer-readable storage medium of claim 18,
the first entry indicating at least the first identifier associated with the connection, one or more data packets pending to be transmitted, a first status associated with the connection, and a congestion index associated with the first congestion state stored in the second data structure, and
the instructions executable by the processing resource further to identify the first congestion state by searching the second data structure further based on the congestion index indicated in the first entry.

20. The non-transitory computer-readable storage medium of claim 18,
the first entry in the first data structure indicating at least the first identifier associated with the connection, one or more data packets pending to be transmitted, and a first status associated with the connection,
the second entry in the second data structure indicating at least a second status associated with the first congestion state and one or more of a congestion window size and a congestion rate, and
the instructions executable by the processing resource further to:
identify the first congestion state by searching the second data structure further based on an encoding associated with the first identifier; and
schedule the data packet further based on the first status and the second status.
